(19) United States
(12) Patent Application Publication
(10) Pub. No.: US 2023/0150701 A1
(43) Pub. Date: May 18, 2023

(54) UNMANNED AIRCRAFT

(71) Applicant: F-DRONES PTE. LTD., Singapore (SG)

(72) Inventors: Yeshwanth Reddy YARTHA, Singapore (SG); Yiong Ann ANG, Singapore (SG)

(21) Appl. No.: 17/919,576

(22) PCT Filed: Apr. 23, 2021
(86) PCT No.: PCT/SG2021/050229

§ 371 Date: Oct. 18, 2022

(30) Foreign Application Priority Data
Apr. 27, 2020 (SG) 10202003837U

(51) Int. Cl. B64U 10/16; B64U 30/295

(52) U.S. Cl. CPC B64U 10/16; B64U 30/295; B64U 2101/60

(57) ABSTRACT

Disclosed is a tail-sitter aircraft. The aircraft comprises a fuselage for carrying a payload, a first lift body and a second lift body offset from the first lift body normal to a plane of the first lift body, and one or more first rotors and one or more second rotors. The first rotor(s) are mounted to the first lift body and the second rotor(s) are mounted to the second lift body. The aircraft also includes a controller that, in some cases, is configured to change a speed of one or more of said propulsion units relative to a speed of one or more other ones of said propulsion units, to adjust an orientation of the aircraft around one or more primary axes. The primary axes are the pitch, roll and yaw axes. In some cases, a position of the payload relative to the lift bodies is adjustable.

### TECHNICAL FIELD

The present invention relates, in general terms, to unmanned aircraft and, in particular, to tail-sitter aircraft.

### BACKGROUND

Long range deliveries in industries like Maritime, Mining, Plantations, inter-island logistics etc., are very expensive, manpower intensive and time consuming. Autonomous aerial deliveries can help reduce costs, time and manpower requirements. The existing long range delivery UAVs need large infrastructure to take-off and land and/or are not compact enough to land at target destinations.

In addition, the Beyond Visual Line of Sight (BVLOS) autonomous aerial deliveries are highly regulated in terms of safety and reliability requirements. Mechanisms such as control surfaces and tilt rotors increase the risk of failure as well as the cost of production.

The size and weight of payloads that need to be sent vary largely for every delivery. Current unmanned aerial vehicles (UAVs) are limited to a very narrow range of payload sizes due to the stability effects on aircraft due to changes in centre of gravity (CoG).

It is desirable therefore to provide a UAV that is highly compact in size and able to land/take-off from restricted spaces with greater hover stability. It is also desirable to provide a UAV capable of carrying payloads of a wide range of sizes without impacting the CoG and thus the controllability of the UAV. It is further desirable to provide a UAV with improved reliability.

### SUMMARY

The bi-plane tail-sitter designs disclosed herein are each a transition aircraft capable of taking-off/landing vertically and cruising in fixed-wing mode during forward flight. Embodiments of the design comprise two staggered lifting bodies or surfaces (wings) stacked one over the other, an eight rotor distributed propulsion system with four rotors mounted on each wing and their rotor axis parallel to these wings, and a fuselage, with payload bay, in-between them.

While on ground, the aircraft sits on its tail with wing leading edges facing up. It then takes-off vertically and the entire airframe (i.e. fuselage, wings, propulsion units and all other components) subsequently pitches 90°, orienting the wings parallel to the ground, to transition from hover to forward flight (cruise) mode in fixed wing mode. A flight or aircraft controller controls the distributed propulsion system during hover, transition from hover to forward flight mode and back, and forward flight modes, and may also navigate the aircraft to its destination. The eight rotors can be controlled in any combination so as to provide pitch, roll and yaw attitude changes as demanded by the controller in hover mode as well as forward flight mode, without the need for traditional control surfaces or tilt mechanisms.

During the forward flight phase or mode, the fuselage and/or payload bay is programmed to automatically slide back and forth longitudinally to counter changes in CoG of the aircraft. Changes in the location of the CoG from the optimum location can be determined based on propulsion power consumption feedback—e.g. rotor RPM feedback from each of the rotors—when loaded with payloads of varying sizes and weights. The position of the fuselage and/or payload bay can also be adjusted while on the ground mechanically.

The field of application is in autonomous aerial delivery of packages for industrial logistics.

Disclosed herein is a tail-sitter aircraft comprising:
a fuselage for carrying a payload;
a first lift body and a second lift body offset from the first lift body normal to a plane of the first lift body; and
one or more first propulsion units mounted to the first lift body and one or more second propulsion units mounted to the second lift body, wherein a speed of each of the one or more first propulsion units is controlled, relative to a speed of each of the one or more second propulsion units, to adjust an orientation of the aircraft around one or more primary axes.

The speed of each of the one or more first propulsion units may be controlled, relative to a speed of each of the one or more second propulsion units, to adjust a pitch of the aircraft.

Notably, the term “speed” as used with reference to propulsion units will be the speed at which the propulsion unit runs. A higher speed therefore means more propulsion and lower speed means less propulsion. For a rotor, the speed will be measured in revolutions per minute (RPM).

The fuselage may be disposed between the first lift body and second lift body.

The tail-sitter aircraft may comprise no control surfaces. In other embodiments, the aircraft includes one or more control surfaces. The term “control surfaces” refers to surfaces that can be repositioned (e.g. rotated), for example relative to the wing or wings, to control one or more of pitch, yaw and roll of the aircraft. That term does not refer to the main lift surface of a wing or, for example where the propulsion unit comprises a rotor, the rotor blades of the rotor. The term “control surfaces” therefore generally refers to ailerons, elevators and flaps. In some embodiments, the term “control surfaces” may also refer to rudders and the like. Therefore, in stating that there are no control surfaces, adjustment of the pitch is controlled entirely by the one or more first propulsion units and the one or more second propulsion units.

In addition, the angle of the propulsion units on the wings may be fixed, while maintaining the same control of pitch, yaw and/or roll by controlling the relative speeds of the propulsion units.

The second lift body may be offset from the first lift body in a direction of travel of the aircraft. The second lift body may be rearwardly offset relative to the direction of travel, and the first lift body may be located above the fuselage when the aircraft is in a forward flight mode.

The controller may be configured to control a relative speed of two or more propulsion units to control a yaw of the aircraft. Each first propulsion unit may form a pair with another first propulsion unit, a centre of gravity of the aircraft being located between the first propulsion units in each pair, during forward flight mode, and the propulsion units in at least one said pair of propulsion units may be controllable to operate at respectively different speeds to adjust a yaw of the aircraft. Alternatively, or in addition, the same may apply for the second propulsion units. Similarly, the controller may be configured to control a relative speed of two or more propulsion units to control a roll of the aircraft.

The propulsion units may include four said first propulsion units and four said second propulsion units. In total, eight propulsion units. The four first propulsion units and four second propulsion units may be spaced along the first and second lift bodies, with two first propulsion units and two second propulsion units being located either side of the fuselage during forward flight mode.

The first lift body may comprise a wing and the second lift body may also comprise a wing. The lift bodies may also respectively include a support for mounting the wing to the fuselage.

The fuselage may comprise an adjustment mechanism for controlling a position of a payload relative to the first lift body and/or second lift body. Notably, the position of the payload may be changed by changing the position of the payload within the fuselage, where the fuselage may be fixed in relation to the lift bodies, or by moving the fuselage relative to the lift bodies.

Each propulsion unit may comprise a rotor.

Also disclosed herein is an unmanned aircraft comprising:
a fuselage;
an adjustment mechanism on the fuselage;
a first lift body and a second lift body; and
one or more propulsion units mounted to the first lift body and/or the second lift body,
   wherein the adjustment mechanism is configured to control a position of at least one of a payload and fuselage, relative to the first lift body and second lift body, for forward flight mode of the aircraft. Notably, the position of the payload may be changed by changing the position of the payload within the fuselage, where the fuselage may be fixed in relation to the lift bodies, or by moving the fuselage relative to the lift bodies. In the latter case, the payload or payload bay may be in a fixed location in the fuselage.

The adjustment mechanism may be configured to secure the payload in one of a plurality of discrete locations spaced in a direction of travel of the aircraft during forward flight mode.

The adjustment mechanism may be configured to secure the payload along a continuum extending in a direction of travel of the aircraft during forward flight mode.

The adjustment mechanism may comprise at least one of:
a rail; and
one or more rollers for engaging the rail, mounted to the fuselage.

The roller may be attached to a servomotor that is activated to move the roller along the rail.

The aircraft may also comprise:
a sensor unit for determining a position of a CoG of the aircraft; and
a payload controller for:
   comparing the position to a desired position for the CoG; and
   controlling the adjustment mechanism to move the payload relative to the first lift body and/or the second lift body to match the position and the desired position, if the position does not match the desired position. The payload controller may be the same controller as the flight controller in the fuselage, that controls the flight of the aircraft to a predetermined destination, or it may be a separate controller. Similarly, the sensor unit may form part of the flight controller or be separate therefrom.

The adjustment mechanism may be configured to control the position of the payload in a direction of travel, or perpendicular to the direction of travel, of the aircraft in a forward flight mode.

The adjustment mechanism may comprise a rack and pinion arrangement.

The adjustment mechanism may control an angle of the fuselage with respect to one of the lift bodies, ground and direction of travel.

Also disclosed herein is an unmanned aircraft comprising:
a fuselage for carrying a payload;
at least one lift body;
one or more propulsion units mounted to each lift body;
a dynamic payload securing system in the fuselage; and
   a payload controller controls a dynamic payload securing system to control or maintain a position of a payload in the fuselage.

The unmanned aircraft described above may be a tail-sitter aircraft as also described above. Thus, the aircraft may provide for pitch control without the use of control surfaces, and for adjustment of the centre of gravity by enabling the payload to be located at a position to optimise the location of the centre of gravity of the aircraft during forward flight mode.

Advantageously, by avoiding the need for control surfaces in forward flight mode, reliability is enhanced and the number of moving parts (e.g. control surface actuators) is generally reduced when compared with aircraft that use control surfaces.

Advantageously, the first a second lift bodies are offset perpendicular to the direction of travel during forward flight mode. By stacking the wings in this manner, the dimensions of the aircraft can be reduced—in some embodiments by 40% or more—when compared with a single-wing aircraft of comparable take-off weight.

Advantageously, by providing propulsion units (generally rotors) on both wings and lift bodies, control of the aircraft is enhanced when compared with propulsion units mounted to a single wing. Moreover, by avoiding control surfaces, the control of pitch, yaw and/or roll is not dictated by the surface area of those control surfaces. Instead, far higher moments can be generated using, for example, rotor speed control.

Advantageously, by enabling the position of the payload to be adjusted, greater control of in-flight CoG can be achieved to facilitate more efficient forward flight during forward flight mode.

Advantageously, by enabling relative propulsion unit speed control, the thrust to weight ratio of each propulsion unit can be chosen so that even if 1 or 2 propulsion units fail during flight, the aircraft will be able to continue flight in a controlled manner.

### BRIEF DESCRIPTION OF THE DRAWINGS

Embodiments of the present invention will now be described, by way of non-limiting example, with reference to the drawings in which:

FIG. 1 is a side view of a first embodiment of an aircraft in accordance with the present invention, in a forward flight mode;

FIG. 2 is a bottom view of the aircraft of FIG. 1, in a vertical take-off/landing, or rest position;

FIG. 3 is a rear view of the aircraft shown in FIG. 1;

FIGS. 4 to 7 show an alternative embodiment of a mechanism for securing lift bodies to the fuselage, comprising an adjustment mechanism;

FIG. 8 is a front view of the aircraft of FIG. 1, showing an exemplary rotor rotation configuration;

FIG. 9 is a rear view of the aircraft shown in FIG. 1, showing the spacing between lift bodies;

FIG. 10 is a side view of the aircraft shown in FIG. 2;

FIG. 11 is a front view of an alternative embodiment of an aircraft in accordance with the present invention;

FIGS. 12 to 14 are a bottom, right and top view respectively, of the aircraft of FIG. 11;

FIGS. 15 to 17 show the placement of the nose and tail of the fuselage of the aircraft of FIG. 11 relative to the lift bodies;

FIGS. 18 to 20 show the adjustment mechanism of the aircraft of FIG. 11, used to shift the wing forward or rearward on the fuselage;

FIG. 21 shows a further embodiment of an aircraft in accordance with present teachings;

FIGS. 22, 23 and 24 show the aircraft of FIG. 21 in various orientations; and

FIG. 25 shows a fuselage containing a dynamic payload securement system (DPSS) in accordance with present teachings; and

FIG. 26 shows the DPSS of FIG. 25 adapting to accommodate differently sized payloads.

### DETAILED DESCRIPTION

As described with reference to the drawings, present aircraft enable a more reliable, controllable flight, by reducing the number of moving parts. Specifically, in many embodiments, control surfaces can be entirely avoided. Also in many embodiments, the position of the CoG of the aircraft can be optimised to enable efficient and longer-distance flights.

The embodiments described with reference to the drawings are generally provided in the context of a tail-sitter aircraft comprising two wings. The term “tail-sitter aircraft” refers to an aircraft that sits on its tail—generally the rearmost portion of the aircraft when in forward flight mode—while not flying. It will be understood, however, that many of the present teachings, particularly those relating to CoG position adjustment, can be applied to single wing or non-tail-sitter aircraft.

The aircraft illustrated in the drawings fly in generally five phases. These phases include a “vertical take-off phase” in which the aircraft takes off vertically, a “forward transition phase” in which the aircraft pitches from its position in the vertical take-off phase and the desired position in forward flight mode, “forward flight mode or forward flight phase” wherein the aircraft travels generally horizontally from an origin to a destination, a “backward transition phase” in which the aircraft pitches from its position in the forward flight mode to its position in a vertical landing phase, and the “vertical landing phase” in which the aircraft lands. Some of these phases will be referenced in the description below.

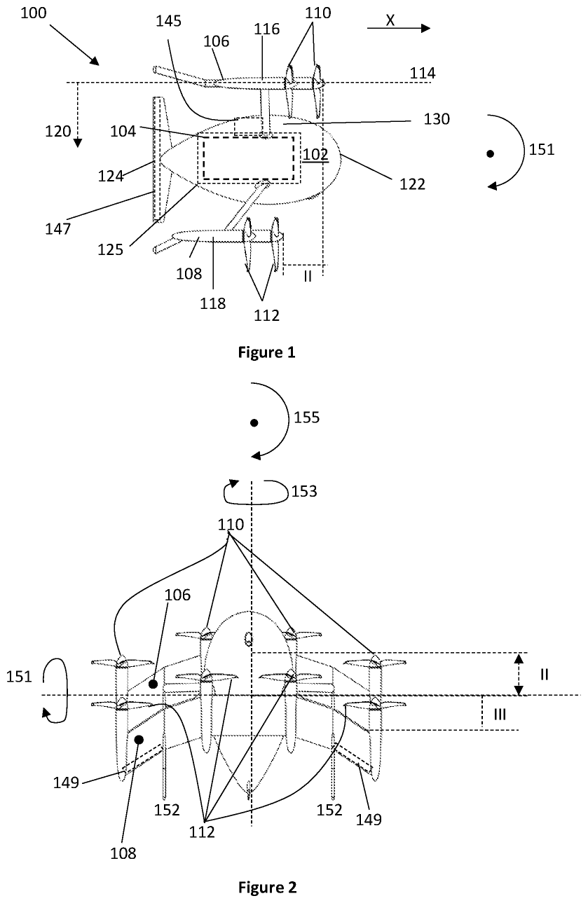

As shown in FIG. 1, a tail-sitter aircraft 100 broadly comprises:
a fuselage 102 for carrying a payload 104;
a first lift body 106 and a second lift body 108;
one or more first propulsion units 110 and one or more second propulsion units 112; and
a controller 145.

The fuselage 102 is shaped to be aerodynamically efficient—i.e. it has low drag. The fuselage 102 is disposed between the lift bodies 106, 108. In some embodiments designed for payload position control, there may be a single lift body or wing, or the lift bodies may be provided on the same side of the fuselage.

As shown in FIG. 2, the second lift body 108 is offset, presently by distance II, from the first lift body 106 parallel to a plane 114 of the first lift body 106. The second lift body 108 is therefore offset from the first lift body 106 in a direction of travel X of the aircraft. This offset places the second lift body 108 rearwardly of the first lift body 106, relative to the direction of travel X. In addition, the first lift body 106 is located above the fuselage 102 when the aircraft is in a forward flight mode.

In general, the lift bodies will comprise a wing 116, 118 having a plane that is substantially aligned with the direction of travel X during forward flight mode. Usually, that plane 114 will be horizontal during forward flight mode and thus a normal 120 to that plane 114 will be substantially vertical.

The first propulsion units 110 are mounted to the first lift body 106 and the second propulsion units 112 mounted to the second lift body 108. There are presently four of each of propulsion units 110 and 112, though in some embodiments a single propulsion unit may be provided, or any number of first propulsion units and second propulsion units (i.e. propulsion units on respective lift bodies or wings) may be provided. Similarly, any desired number of lift bodies may be provided, such as a single lift body, two as shown, or three or more.

The propulsion units 110, 112 are spaced along the lift bodies 106, 108, two propulsion units located either side of the fuselage 102 during forward flight mode. For some propulsion unit control schema, the propulsion units may be considered to be paired, with the two propulsion units closest to the fuselage 102 on one lift body being considered a pair, and the next outer propulsion units also forming a pair—thus the CoG of the aircraft will typically be positioned between the propulsion units of each pair. In other words, the propulsion units in each pair are provided on the same lift body, on opposite sides of the fuselage.

The controller 145 is configured to change a speed of at least one propulsion unit relative to a speed of at least one other propulsion unit (i.e. control two or more such propulsion units such that their speeds differ), to adjust an orientation of the aircraft around one or more primary axes. The primary axes are the standard pitch, roll and yaw axes. The pitch, roll and yaw axes will be understood by the skilled person, and are indicated by arrows 151, 153 and 155 rotating about a line where the relevant primary axis lies in the plane of the figure, and rotation about a dot where the relevant primary axis extends into the page.

During yawing, the controller 145 controls the speed of the propulsion units in one or more pairs such that they are dissimilar—i.e. one of the propulsion units in a pair runs at one speed, and the other propulsion unit in the same pair runs at a different speed. The faster propulsion unit drives the aircraft to turn towards the opposite side. For example, rotors 148-1 and 148-8 may form a pair and rotors 148-2 and 148-7 may form another pair, with rotor 148-1 operating at a different speed to rotor 148-8 during yawing, and the same for rotors 148-2 and 148-7. Rotors 148-1 and 148-2 may operate at the same speed.

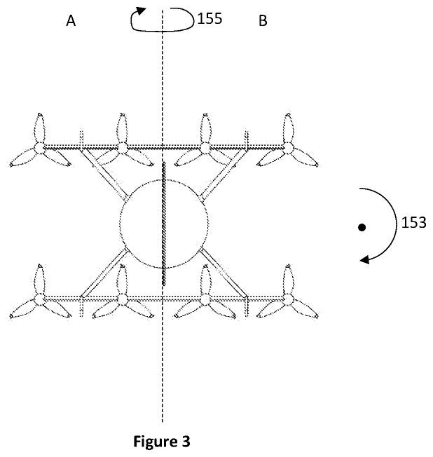

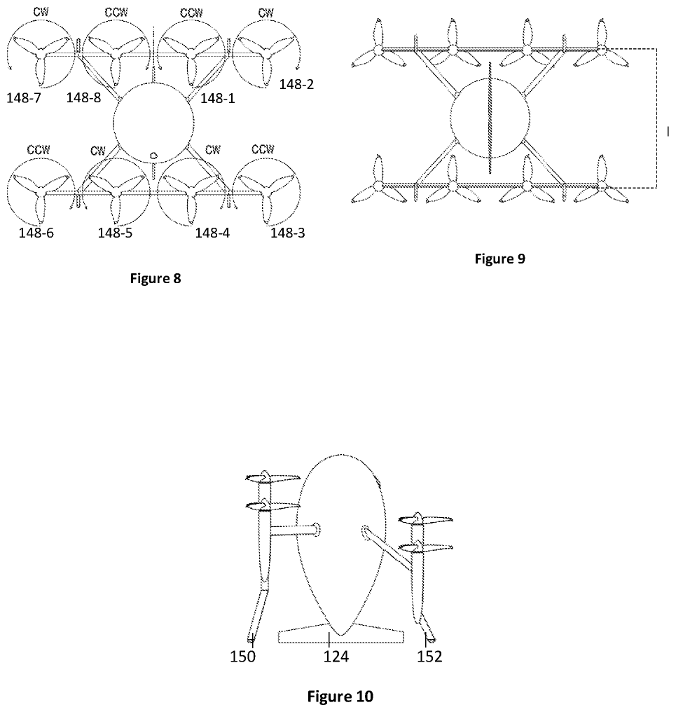

During flight, pitch, yaw and roll should be controlled to maintain control of the aircraft. To control pitch, the speed of the first propulsion units and the speed of the second propulsion units differ—i.e. a speed of each first propulsion unit 110 is controlled, relative to a speed of each second propulsion unit 112. As a result, one of the bodies 106, 108 is driven forward in direction X relative to the other body 106, 108, resulting in a change in pitch. To control yaw, the speed of the propulsion units on one side (see sides A and B in FIG. 3) of the fuselage 102 are controlled relative to the speed of the propulsion units on the other side (A or B) of the fuselage 102 as discussed above. With reference to FIG. 8, to control roll the speed of propulsion units 148-2, 148-4, 148-5 and 148-7 (i.e. those that rotate in a clockwise direction) is varied relative to the speed of propulsion units 148-1, 148-3, 148-6 and 148-8 (i.e. those that rotate in a counter-clockwise or anti-clockwise direction). The skilled person will appreciate that the speed of only a subset—i.e. not necessarily all—of propulsion units needs to be varied in order to result in a change in orientation of the aircraft. In other cases, the speed of all relevant propulsion units may be concurrently varied.

By controlling the speed of the propulsion units 110, 112, each of which will generally be or comprise a rotor, the tail-sitter aircraft need include no control surfaces. In some embodiments, however, one or more control surfaces, such as rudder 147 or ailerons 149, may be provided.

While the first and second propulsion units and lift bodies are described in the configuration shown, they can be swapped (i.e. comments relating to the “first lift body” or “first propulsion units” can be similarly applied to the “second lift body” and “second propulsion units”, and vice versa, and there may be additional or fewer propulsion units lift bodies to those shown) while remaining in line with present teachings.

For stability it is also useful to ensure the CoG of the aircraft is located at a specific position relative to the lift bodies. If the CoG is too far forward, energy will be spent trying to continually direct the nose 122 upward. This will result in the second propulsion units being overworked. Conversely, if the CoG is too far rearward, energy will be spent trying to continually direct the nose 122 downward to raise the tail 124. This will result in the first propulsion units being overworked.

The CoG of the unladen aircraft can be accurately determined and the lift bodies configured accordingly. Similarly, the payload bay 125—i.e. the volume within the fuselage for holding the payload 104—can be precisely located to reduce variation in CoG location. However, the precise location of the CoG, and thus the relative positions of the lift bodies 106, 108 and fuselage 102, may differ between payloads. Therefore, an arrangement of lift bodies and fuselage for one payload may not be the optimum for a different payload.

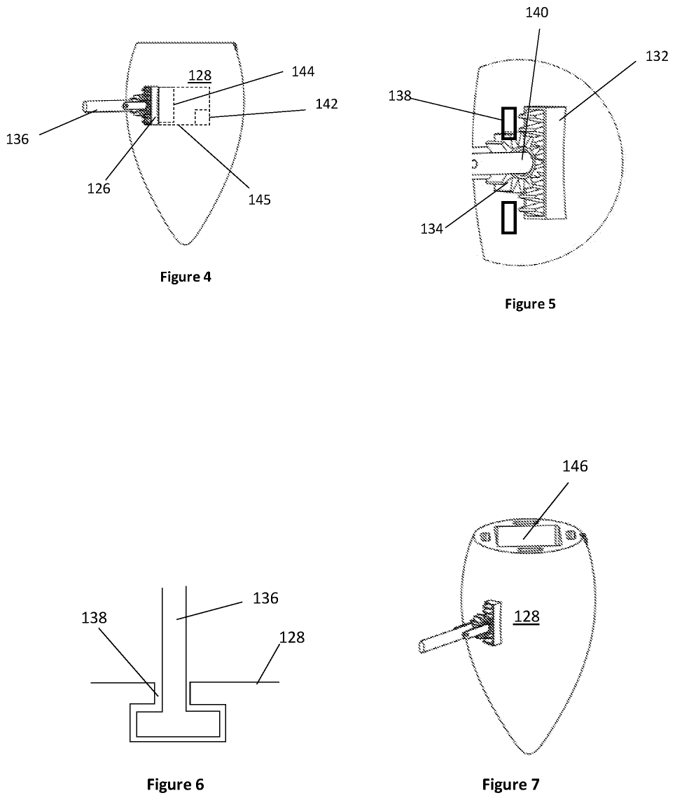

To assist with positioning the CoG the aircraft 100, which is unmanned, may include an adjustment mechanism 126 on the fuselage 128 shown in FIG. 4, in place of mount 130 shown in FIG. 1. The adjustment mechanism 126 is configured to control a position of a payload relative to the first lift body and second lift body, for forward flight mode of the aircraft. The position of the payload may be controlled by moving the payload or payload bay, within the fuselage, or by moving the fuselage, and the payload along with it, relative to the lift bodies. The lift bodies are the same as those shown in FIGS. 1 to 3 and have therefore been excluded from FIG. 4 to more clearly show the adjustment mechanism 126.

The adjustment mechanism 126 is configured to secure the payload along a continuum extending in a direction of travel of the aircraft during forward flight mode. In other embodiments, the adjustment mechanism may be configured to secure the payload in one of a plurality of discrete locations spaced in a direction of travel of the aircraft during forward flight mode—e.g. by providing locking holes at spaced locations along a rail mounted to the fuselage to which, when the rail is external, one or both of the lift bodies can be attached and, when the rail is internal, the payload can be attached. The payload itself may be shifted along from one discrete location to the next within the fuselage, or the payload bay may be shifted between discrete locations in the fuselage thereby to move the payload. In this latter case, there is no need to provide a carriage to match the payload since generally the same payload bay will be used for all payloads. Alternatively, the fuselage may be shifted relative to the lift bodies, to enable it to be secured relative to the lift bodies at a desired discrete location. The payload, payload bay or fuselage may be shifted manually while the aircraft is on the ground, or may be shifted automatically—e.g. while in flight—once the aircraft controller determines the CoG is at a sub-optimal position.

With regard to automatic adjustment, the controller 145 may adjust the position of the fuselage 102 with respect to the lift bodies 106, 108 or the direction of travel, or both, to maintain efficient flight—e.g. to keep drag on the fuselage 102 low. Such a system may be pre-programmed or may dynamically adjust the position of the fuselage 102 with respect to the lift bodies 106, 108 or the direction of travel, or both. In some embodiments, the controller 145 may thus control an active drag reduction system (A-DRS). The A-DRS is a mechanism whereby the fuselage is controlled relative to the lift body or lift bodies such that the angle of attack of the fuselage can differ from the angle of attack of one or more of the lift bodies. In particular, the fuselage 102 of the aircraft 100 maintains a constant angle of attack (angle with respect to the ground), in cruise or forward flight phase, irrespective of the angle of attack of the wings (lift bodies 106, 108). Such a mechanism minimizes drag produced by the fuselage 102 even if the aircraft 100 is required to fly at a higher angle of attack—i.e. the angle of attack of the lift body or lift bodies. In other words, the A-DRS can control the angle of attack of the fuselage to minimise drag on the fuselage, while allowing the lift body or lift bodies to have a different angle of attack necessary to maintain the desired flight path.

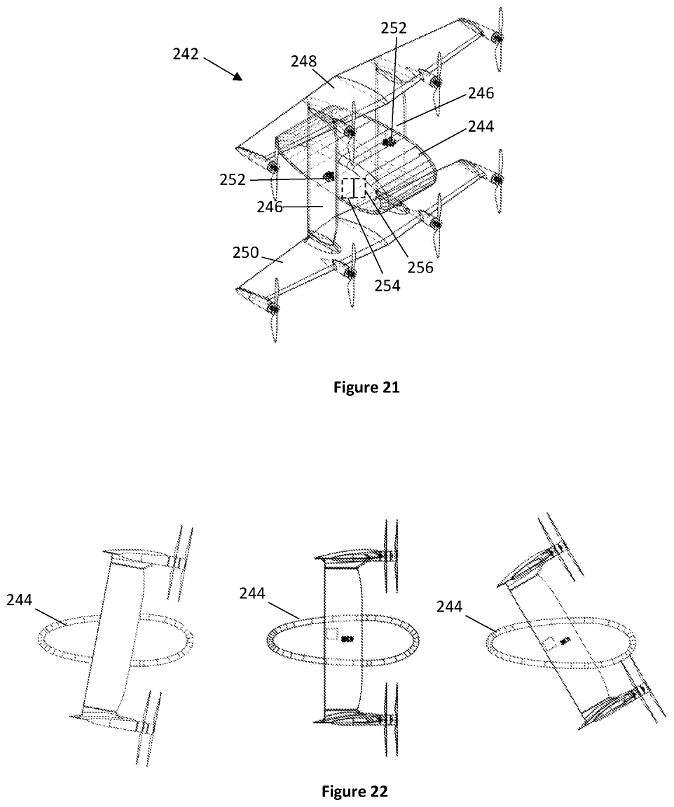

Such a function may be achieved by mounting lift bodies 106 and 108 to the fuselage 102 using systems such as systems 228, 230 of FIGS. 19 and 20. In the embodiment 242 of FIG. 21, the A-DRS may be achieved by mounting the fuselage 244 between two pylons 246. The pylons 246 extend between lift bodies or wings 248, 250. The fuselage 244 is mounted to the pylons 246 by actuators—e.g. servomotors 252.

An Inertial Measurement Unit (IMU) 254 is mounted on the fuselage 244. The IMU 254 actively measures orientation of the fuselage 244 with respect to wings 248, 250. To that end, the IMU 254 may comprise one or more accelerometers, gyroscopes or other sensors by which to detect orientation of the fuselage 244 with respect to the wings 248, 250, the trajectory of flight or ground. A flight controller 256 uses measurements of the orientation from the IMU 254 to control the rotation/orientation of the fuselage 244 throughout, or at particular points (e.g. during the forward transition phase or the backward transition phase from forward flight phase to vertical landing phase) during, the flight. As reflected in FIG. 22, the orientation of the fuselage 244 (i.e. angle of attack) is independent of that of the wings 248, 250. This can also provide stability to the payload, to prevent it from moving around in the payload bay.

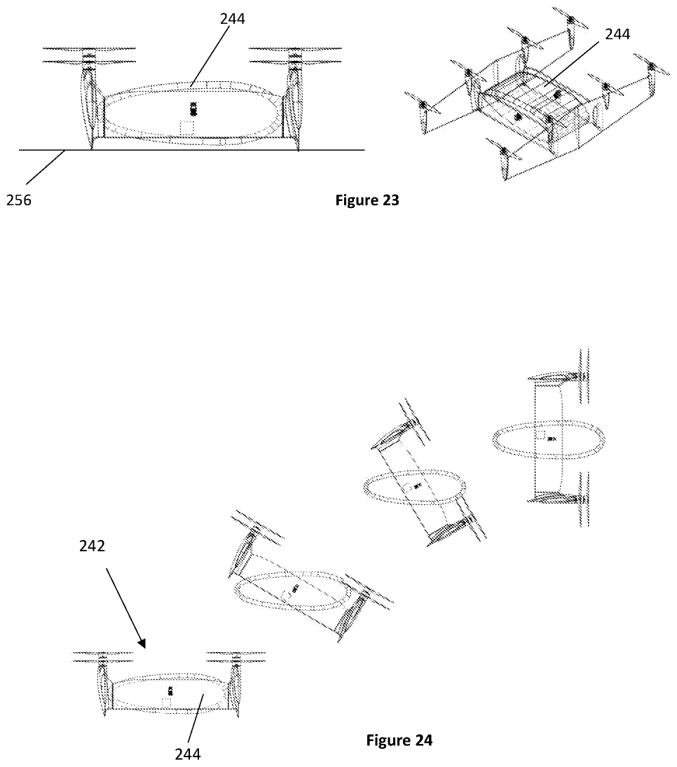

The ability to move the fuselage 244 with respect to the wings 248, 250 also enables the fuselage 244 to be oriented horizontally while the aircraft 242 is stationary—e.g. on the ground, on a ship deck, roof of building etc. This allows a user to place a payload into the fuselage 242 from the top side. This increases ease of use while simultaneously making it simple for the payload to be secured in position, no matter what the dimensions of such a payload is with respect to that of the fuselage 242. In particular, the actuators, presently servomotors 252, enable the fuselage 244 to be oriented with respect to the user, in an orientation either that best suits insertion of the payload into or removal of the payload from the fuselage 244, or that best orients the payload in the fuselage 244 (e.g. for secure flight with the CoG positioned as desired). FIG. 23 shows the fuselage 244 oriented to facilitate access while the device 242 is on the ground 258.

FIG. 24 illustrates the forward transition phase from a rest or loading position on the ground (as also reflected in FIG. 23) to a forward flight phase—left to right in FIG. 24. The aircraft 242 takes off (roughly vertically), with the fuselage 244 remaining horizontal. As the aircraft 242 pitches forward to transition to forward flight mode, the fuselage 244 maintains in orientation or angle of attack.

In the embodiment where the fuselage is shifted relative to the lift bodies, the fuselage may either rotate relative to the lift bodies (e.g. using servomotors as described above), or translate relative to the lift bodies, of both. That shifting can serve multiple purposes including maintaining a position of a CoG relative to the lift body or bodies, controlling or maintaining an angle of attack (i.e. an aerodynamic profile relative to a direction of travel), an orientation of the payload and other purposes. For translation, the adjustment mechanism 126 may include a rail 132 mounted to the fuselage 128 and a roller 134 for engaging the rail—as shown in close-up view in FIG. 5. In other embodiments, the rail may be provided on the lift body support or frame 136, with the roller provided on the fuselage. The roller and rail therefore form a rack and pinion type arrangement.

To maintain the lift body in register with the fuselage 128, the support or frame 136 also includes a slider that is locked into slot 138 of the fuselage 128 in a known manner, such as shown in FIG. 6, to slide along slot 138 but to be unable to dislodge therefrom.

The roller 134 is attached to a servomotor 140 that is activated to move the roller along the rail 136. Activation of the servomotor 140 may be manually controlled—e.g. via control signal to a controller in the fuselage or in the lift body itself—or may be automatically controlled when repositioning of the CoG is desirable. To facilitate automatic adjustment, a sensor unit 142 and payload controller 144 are provided. The sensor unit 142 determines a position of the CoG of the aircraft. The payload controller 144 receives the position of the CoG from the sensor unit 142 and compares that position to a desired position. If there is a match—i.e. the “actual” position of the CoG matches the desired position—then the payload controller 144 does not adjust the location of the payload relative to the lift bodies. If, however, there is not a match, the payload controller 144 controls the adjustment mechanism to move the payload relative to the first lift body and/or the second lift body to match the position and the desired position.

The sensor unit 142 may determine the power consumption of each propulsion unit—e.g. determine the RPM from each of the rotors or the direct energy consumption in Watts. Since power is redistributed through the propulsion units to maintain balance of the aircraft, power consumption across the propulsion units can be used to determine the position of the CoG—i.e. power consumption can be used as a proxy for determining the location of the CoG. Alternatively, the sensor unit 142 may comprise a gyroscope or other device for directly determining “actual” pitch. In this scenario, the payload controller 144 receives a signal from the sensor unit 142, the signal advising the payload controller 144 of the pitch (as measured by the sensor unit 142) of the aircraft. The payload controller 144 compares the pitch to a desired pitch—e.g. the pitch associated with most energy efficient forward flight—and controls the adjustment mechanism (e.g. by controlling the servomotor 140) to move the payload relative to the first lift body and/or the second lift body. That movement is intended to match the pitch and the desired pitch, the comparison performed by the controller shown the pitch does not match the desired pitch. In this sense, a “match” may be that the pitch is exactly the same as the desired pitch—which is predetermined—or may be within a predetermined threshold of the desired pitch—e.g. ±2°. Although the controller is described as moving the payload relative to the first and/or second lift bodies, this can be achieved by moving the fuselage 128 relative to the first and/or second lift bodies using the adjustment mechanism 126, and/or by moving the payload within the payload bay 146 shown in FIG. 7, along a similar rack and pinion type adjustment mechanism or any other suitable adjustment mechanism.

In addition, while a sensor unit and payload controller have been described, this is not to say those components cannot form part of the same unit—e.g. part of a flight controller 145. Moreover, in stating that the sensor unit determines a position of a CoG of the aircraft, this is intended to include within its scope quantities that are equivalent—i.e. that may be a proxy for the CoG of the aircraft—such as the power consumption of the propulsion units or the orientation of the aircraft as may be determined, for example, by a gyroscope.

The present adjustment mechanism 126 is configured to control the position of the payload in a direction of travel, or perpendicular to the direction of travel, of the aircraft in a forward flight mode. Similarly, an adjustment mechanism may be provided to control the lateral position of the CoG—i.e. the position of the CoG perpendicular to the direction of travel generally horizontally, or in the plane of the lift bodies. That may similarly comprise a rack and pinion type adjustment mechanism. For example, a first adjustment mechanism 126 may be provided, to control the longitudinal position of the CoG (e.g. by controlling the location of the lift bodie(s) relative to the fuselage), and a second adjustment mechanism may be provided to control the lateral position of the CoG (e.g. by controlling the lateral position of the payload in payload bay 146). In this context, longitudinal refers to the direction of travel, and lateral refers to the direction normal to the longitudinal direction and parallel to the lift bodies.

Notably, the sensor unit 142, payload controller 144 and flight controller 145 are shown as separate devices. However, these devices 142, 144, 145 may form a single unit, be combined in any desired manner, or may form multiple separate or distributed units, as required for any particular design.

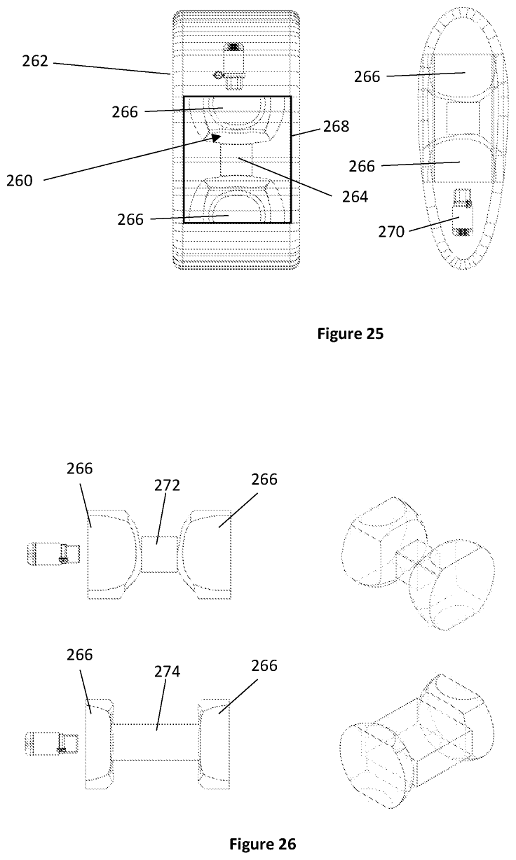

In an alternative embodiment, shown in FIG. 25, the payload controller (not shown) controls a dynamic payload securing system (DPSS) 260. The DPSS 260 is housed in the fuselage 262. The DPSS 260 is for controlling or maintaining a position of a payload 264 in the fuselage 262.

The dimensions of the fuselage 262 are constant. However, it can carry payloads of different sizes. Also, the distribution of weight of the payload may be inconsistent—e.g. some payloads will be heavier at one end than the other. The payload controller (e.g. controller 144) can therefore control the DPSS 260 to accommodate different sized/shaped payloads, payloads of different or non-uniform weight and so on.

The present DPSS 260 comprises airbags 266 housed in the fuselage 262. The airbags 266 may be secured to the fuselage 262 or inserted between the internal walls of the payload bay and payload 264. The airbags 266 are controlled by the payload controller to inflate or deflate based on the size of the payload during each flight. Where it is desired to control the CoG of the payload, one airbag may be inflated more than the other, thereby shifting the payload toward the end of the payload bay with the less inflated airbag. The airbags 266 can be inflated using a small vacuum pump 270. The pump 270 may be fitted along with one or more sensor within the fuselage—the sensors can include one or more pressure sensors to ensure the appropriate pressure is maintained in the airbags 266. Of course, deflation can be managed using a valved vent—e.g. vent with solenoid valve—rather than the vacuum pump, or any other arrangement as will be apparent to the skilled person in view of present teachings. The sensors can also include orientation sensors as mentioned above in relation to aircraft 242, to control a position of the payload relative to an orientation of the wings or fuselage, to ensure proper weight distribution for efficient flight.

FIG. 26 shows two configurations in which, in the top two images, the airbags 266 are inflated to a large degree to secure a small payload 272 and, in the lower to images, the airbags 266 are inflated to a lesser degree to secure a larger payload 274.

With reference to FIG. 8, the rotors form two sets, Set A comprising rotors 148-1, 148-3, 148-5 and 148-7 and Set B comprising rotors 148-2, 148-4, 148-6 and 148-8. The rotors in Set A rotate clockwise (CW) and the rotors in Set B rotate counter-clockwise (CCW), thus balancing the resulting torque during hover and stable flight. The opposite rotation, or other rotation configurations may also be used.

During rest, the aircraft 100 rests on its stabilisers—presently wing stabilisers 150, 152—as shown in FIG. 10, e.g. on the deck of a ship or a take-off/landing pad. FIG. 2 also shows the wing stabilisers 152 (of which there are two, disposed towards opposite ends of lift body 106), with the two wing stabilisers 150 being disposed the same distance apart and thus hidden (in FIG. 2) behind stabilisers 152 It may also rest on the tail 124. After vertical take-off and during transition from hover to forward flight, the RPM of rotors 148-1, 148-2, 148-7 and 148-8 are reduced and the RPM of rotors 148-3, 148-4, 148-5 and 148-6 are increased proportionally for a predefined period until the aircraft pitches 90° along with achieving a forward speed called stall speed. The reverse occurs for transition from forward flight to hover—e.g. when coming to land.

In the forward flight mode, the roll is controlled by increasing and decreasing the RPM of a combination of the rotors in Set A and Set B. Similarly, yaw is controlled by increasing and decreasing the RPM of a combination of the rotors in Set A and those in Set B.

The design of the aircraft described herein may be varied in many ways, to suit the particular application. For example, the propulsion power may be varied, the CoG may be predetermined or specified to be at a particular, desired location, the wing span (i.e. span of the lift bodies), wing area, separation between the wings (I), stagger between wings (II), wing sweep (III), wing dihedral, and connecting mechanism of payload bay with airframe may all be selected to suit a particular design or application, without stepping outside the present teachings.

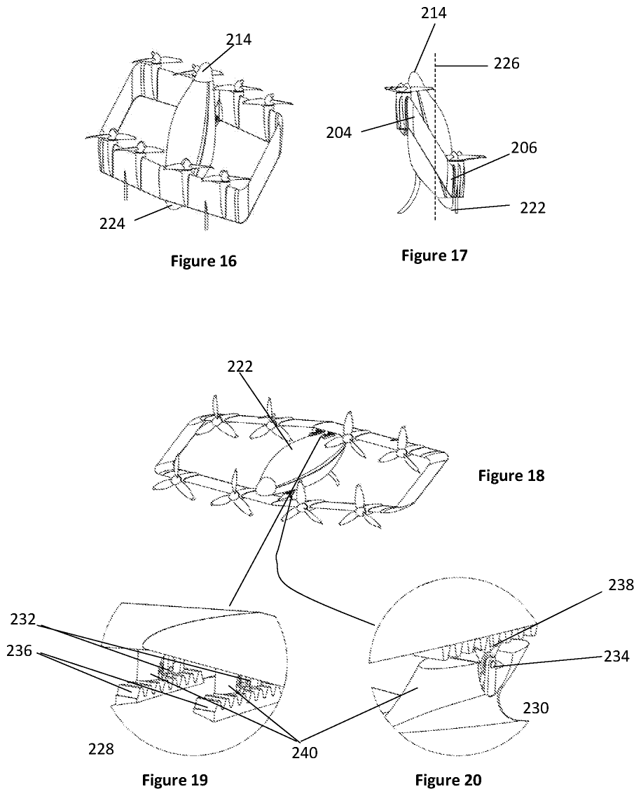

For example, FIGS. 11 to 20 show another aircraft 200 that includes a two lift bodies 204, 206 formed part of a single, continuous wing 208. The aircraft 200 also includes a payload bay 210, eight rotors (numbered 212-1 to 212-8) and a vertical stabiliser 214. Per the embodiments described with reference to FIGS. 1 to 10, the rotors 212-1 to 212-8 mirror the respective functions of rotors 148-1 to 148-8 to produce lift during hover and thrust during forward flight, and the two lift bodies 204, 206 produce lift during forward flight. During transition from hover to forward flight and back, the rotors 212-1 to 212-8 produce a combination of lift and thrust relative to the lift produced by the lift bodies 204, 206.

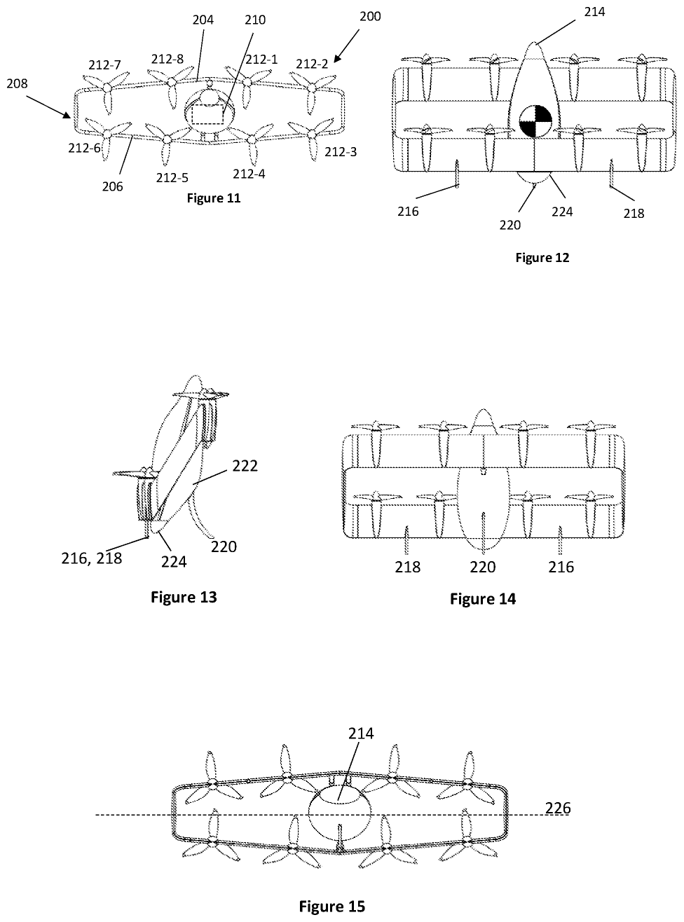

FIG. 12 shows the nose 214 projecting forwardly of the upper lift body 204. This is the configuration during rest—e.g. on a landing pad or deck—and during vertical take-off and vertical landing. While at rest, the aircraft sits on its stabilisers 216, 218, 220. Stabilisers 216, 228 are wing stabilisers, being mounted to the lift bodies 204, 206. Stabiliser 220 is a body stabiliser that is attached to the fuselage 222 as shown in FIGS. 13 and 14. The stabilisers 216, 218, 220 keep the tail 224 off the landing pad during rest.

As shown in FIGS. 15 to 17, the nose is disposed away from the centre-plane 226, towards the upper lift body 204. Similarly, the tail 224 is disposed away from the centre-plane 226 towards the lower lift body 206. Using this configuration, the aerodynamic profile of the aircraft 200 can be preserved, but the length of supports between the wing 208 and the fuselage 222 is reduced.

Aircraft 200 also includes an adjustment mechanism comprising systems 228, 230, shown in FIGS. 18 to 20. The adjustment mechanism shifts the wing 208 relative to the fuselage 222, and therefore relative to the payload contained in the fuselage 222, to control the location of the CoG of the laden aircraft (i.e. with payload). The systems 228, 230 each comprise a two-part arrangement, with one part 232, 234 provided on the respective lift body 204, 206 and the other part 236, 238 provided on the fuselage 222. The parts 232, 236 and 234, 238 move relative to each other to shift the fuselage 222 forward or rearward relative to the direction of travel and the wing 208. As a result, the CoG of the aircraft 200 is similarly shifted forward or rearward.

The adjustment mechanism includes a shield 240 where necessary, to maintain the aerodynamic profile of the aircraft 200 at the adjustment mechanism. To keep the wing 208 on the fuselage 222, a slotted arrangement such as that shown in FIG. 6 may be provided, or another type of arrangement as will be apparent to the skilled person in view of present teachings.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A tail-sitter aircraft comprising:
a fuselage for carrying a payload;
a first lift body and a second lift body offset from the first lift body normal to a plane of the first lift body;
one or more first propulsion units mounted to the first lift body and one or more second propulsion units mounted to the second lift body; and
a controller configured to change a speed of one or more of said propulsion units relative to a speed of one or more other ones of said propulsion units, to adjust an orientation of the aircraft around one or more primary axes.

2. The tail-sitter aircraft of claim 1, wherein the controller is configured to control a speed of each of the one or more first propulsion units, relative to a speed of each of the one or more second propulsion units, to adjust a pitch of the aircraft.

3. The tail-sitter aircraft of claim 1, wherein the fuselage is disposed between the first lift body and second lift body.

4. The tail-sitter aircraft of claim 1, comprising no control surfaces.

5. The tail-sitter aircraft of claim 1, wherein the second lift body is offset from the first lift body in a direction of travel of the aircraft.

6. The tail-sitter aircraft of claim 5, wherein the second lift body is rearwardly offset relative to the direction of travel, and the first lift body is located above the fuselage when the aircraft is in a forward flight mode.

7. The tail-sitter aircraft of claim 1, wherein the controller is configured to control a relative speed of two or more propulsion units to control a yaw of the aircraft.

8. The tail-sitter aircraft of claim 1, wherein the controller is configured to control a relative speed of two or more propulsion units to control a roll of the aircraft.

9. The tail-sitter aircraft of claim 1, comprising four said first propulsion units and four said second propulsion units.

10. The tail-sitter aircraft of claim 9, wherein the four first propulsion units and four second propulsion units are spaced along the first and second lift bodies, with two first propulsion units and two second propulsion units being located either side of the fuselage during forward flight mode.

11. The tail-sitter aircraft of claim 1, wherein the first lift body comprises a wing and the second lift body comprises a wing.

12. The tail-sitter aircraft of claim 1, wherein the fuselage comprises an adjustment mechanism for controlling a position of the payload relative to the first lift body and/or second lift body.

13. The tail-sitter aircraft of claim 1, wherein each propulsion unit comprises a rotor.

14. An unmanned aircraft comprising:
a fuselage for carrying a payload;
an adjustment mechanism on the fuselage;
a first lift body and a second lift body; and
one or more propulsion units mounted to the first lift body and/or the second lift body,
wherein the adjustment mechanism is configured to control a position of at least one of the payload and fuselage, relative to the first lift body and second lift body, for forward flight mode of the aircraft.

15. The unmanned aircraft of claim 14, wherein the adjustment mechanism is configured to secure the payload in either:
one of a plurality of discrete locations spaced in a direction of travel of the aircraft during forward flight mode; and
along a continuum extending in a direction of travel of the aircraft during forward flight mode.

16. The unmanned aircraft of claim 14, wherein the adjustment mechanism comprises at least one of:
a rail; and
one or more rollers for engaging the rail,
mounted to the fuselage.

17. The unmanned aircraft of claim 16, comprising:
a sensor unit for determining a position of a centre of gravity (CoG) of the aircraft; and
a payload controller for:
comparing the position to a desired position for the CoG; and
controlling the adjustment mechanism to move the payload relative to the first lift body and/or the second lift body to match the position and the desired position, if the position does not match the desired position.

18. The unmanned aircraft of claim 17, wherein the sensor unit determines the position of the CoG of the aircraft by determining a relative power consumption of two or more of the propulsion units.

19. The unmanned aircraft of claim 14, wherein the adjustment mechanism is configured to control one or more of the position of the payload in a direction of travel or perpendicular to the direction of travel, and an angle of attack of the aircraft in a forward flight mode.

20. (canceled)

21. An unmanned aircraft comprising:
a fuselage for carrying a payload;
at least one lift body;
one or more propulsion units mounted to each lift body;
a dynamic payload securing system in the fuselage; and
a payload controller controls a dynamic payload securing system to control or maintain a position of a payload in the fuselage.

22. (canceled)
